(19) United States
(12) Patent Application Publication
(10) Pub. No.: US 2016/0054915 A1
(43) Pub. Date: Feb. 25, 2016

(54) SYSTEMS AND METHODS FOR PROVIDING INFORMATION TO A USER ABOUT MULTIPLE TOPICS

(71) Applicant: Nuance Communications, Inc., Burlington, MA (US)

(72) Inventors: Timothy Lynch, Reading, MA (US); Kristen Deveau, Burlington, MA (US); Joshua Lipe, Burlington, MA (US)

(21) Appl. No.: 14/467,186

(22) Filed: Aug. 25, 2014

(51) Int. Cl. G06F 3/0488; G06F 3/0484; G06F 17/30

(52) U.S. Cl. CPC G06F 3/04883; G06F 17/30598; G06F 3/04842

(57) ABSTRACT

Techniques of presenting information to a user via a display of a device. The techniques comprising: displaying information about a first topic in a first content category; and while displaying the information about the first topic: in response to detecting first user input corresponding to a first type of gesture, displaying information about a second topic in a second content category different from the first content category; in response to detecting second user input corresponding to a second type of gesture, displaying first alternative type of information about the first topic, wherein no indicia describing content of the first alternative type of information about the first topic is displayed prior to detecting the second user input, wherein, while information about a particular topic is being displayed, the second type of gesture is dedicated to causing an alternative type of information about the particular topic to be displayed, and wherein the second type of gesture is different from the first type of gesture.

### BACKGROUND

A user of a computing device may use one or more application programs installed on the computing device and/or one or more websites accessible via a web-browser executing on the computing device to obtain information about different topics of interest to the user. For example, the user may use one application program to obtain information about weather at the user's location and another application program to obtain information about current prices of stocks the user is following.

### SUMMARY

Some embodiments are directed to a method of presenting information to a user via a display of a device. The method comprises displaying information about a first topic in a first content category; and while displaying the information about the first topic in response to detecting first user input corresponding to a first type of gesture, displaying information about a second topic in a second content category different from the first content category; in response to detecting second user input corresponding to a second type of gesture, displaying first alternative type of information about the first topic, wherein no indicia describing content of the first alternative type of information about the first topic is displayed prior to detecting the second user input wherein, while information about a particular topic is being displayed, the second type of gesture is dedicated to causing an alternative type of information about the particular topic to be displayed, and wherein the second type of gesture is different from the first type of gesture.

Some embodiments are directed to at least one non-transitory computer-readable storage medium storing processor-executable instructions that, when executed by at least one computer hardware processor, cause the at least one computer hardware processor to perform a method of presenting information to a user via a display of a device. The method comprises displaying information about a first topic in a first content category; and while displaying the information about the first topic in response to detecting first user input corresponding to a first type of gesture, displaying information about a second topic in a second content category different from the first content category; in response to detecting second user input corresponding to a second type of gesture, displaying first alternative type of information about the first topic, wherein no indicia describing content of the first alternative type of information about the first topic is displayed prior to detecting the second user input wherein, while information about a particular topic is being displayed, the second type of gesture is dedicated to causing an alternative type of information about the particular topic to be displayed, and wherein the second type of gesture is different from the first type of gesture.

Some embodiments are directed to a system comprising at least one hardware processor and at least one non-transitory computer-readable storage medium storing processor-executable instructions that, when executed by the at least one computer hardware processor, cause the at least one computer hardware processor to perform a method of presenting information to a user via a display of a device. The method comprises displaying information about a first topic in a first content category; and while displaying the information about the first topic in response to detecting first user input corresponding to a first type of gesture, displaying information about a second topic in a second content category different from the first content category; in response to detecting second user input corresponding to a second type of gesture, displaying first alternative type of information about the first topic, wherein no indicia describing content of the first alternative type of information about the first topic is displayed prior to detecting the second user input wherein, while information about a particular topic is being displayed, the second type of gesture is dedicated to causing an alternative type of information about the particular topic to be displayed, and wherein the second type of gesture is different from the first type of gesture.

Some embodiments are directed to a method performed by at least one computer. The method comprises: identifying, based on information about a user of a client computing device, at least one topic including a first topic in a first content category and a second topic in a second content category different from the first content category; obtaining a first set of content about the first topic and a second set of content about the second topic, the first set of content comprising a first piece of content about the first topic and second piece of content about the first topic, the obtaining comprising: obtaining the first piece of content from a first content provider; and obtaining the second piece of content from a second content provider different from the first content provider, wherein the first piece of content and the second piece of content are alternative types of content about the first topic; generating metadata for the first and second sets of content, the metadata comprising: information indicating a particular piece of content in the first set of content to display to the user first; information indicating which piece of content in the first set of content to display to the user in response to receiving, while displaying the particular piece of content, user input indicating that an alternative type of information about the first topic is to be displayed; information indicating which piece of content in the second set of content to display to the user in response to receiving, while displaying the particular piece of information, user input indicating that information about a topic in a content category different from the first content category is to be displayed; and transmitting the first set of content, the second set of content, and the generated metadata to the client computing device.

Some embodiments are directed to at least one non-transitory computer-readable storage medium storing processor-executable instructions that, when executed using at least one computer, cause the at least one computer to perform a method. The method comprises: identifying, based on information about a user of a client computing device, at least one topic including a first topic in a first content category and a second topic in a second content category different from the first content category; obtaining a first set of content about the first topic and a second set of content about the second topic, the first set of content comprising a first piece of content about the first topic and second piece of content about the first topic, the obtaining comprising: obtaining the first piece of content from a first content provider; and obtaining the second piece of content from a second content provider different from the first content provider, wherein the first piece of content and the second piece of content are alternative types of content about the first topic; generating metadata for the first and second sets of content, the metadata comprising: information indicating a particular piece of content in the first set of content to display to the user first; information indicating which piece of content in the first set of content to display to the user in response to receiving, while displaying the particular piece of content, user input indicating that an alternative type of information about the first topic is to be displayed; information indicating which piece of content in the second set of content to display to the user in response to receiving, while displaying the particular piece of information, user input indicating that information about a topic in a content category different from the first content category is to be displayed; and transmitting the first set of content, the second set of content, and the generated metadata to the client computing device.

Some embodiments are directed to a system comprising at least one computer; and at least one non-transitory computer-readable storage medium storing processor-executable instructions that, when executed using the at least one computer, cause the at least one computer to perform a method. The method comprises: identifying, based on information about a user of a client computing device, at least one topic including a first topic in a first content category and a second topic in a second content category different from the first content category; obtaining a first set of content about the first topic and a second set of content about the second topic, the first set of content comprising a first piece of content about the first topic and second piece of content about the first topic, the obtaining comprising: obtaining the first piece of content from a first content provider; and obtaining the second piece of content from a second content provider different from the first content provider, wherein the first piece of content and the second piece of content are alternative types of content about the first topic; generating metadata for the first and second sets of content, the metadata comprising: information indicating a particular piece of content in the first set of content to display to the user first; information indicating which piece of content in the first set of content to display to the user in response to receiving, while displaying the particular piece of content, user input indicating that an alternative type of information about the first topic is to be displayed; information indicating which piece of content in the second set of content to display to the user in response to receiving, while displaying the particular piece of information, user input indicating that information about a topic in a content category different from the first content category is to be displayed; and transmitting the first set of content, the second set of content, and the generated metadata to the client computing device.

The foregoing is a non-limiting summary of the invention, which is defined by the attached claims.

### BRIEF DESCRIPTION OF DRAWINGS

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1 shows an illustrative environment in which some embodiments of the technology described herein may operate.

FIG. 2 is a flowchart of an illustrative process for presenting information about at least one topic to a user, in accordance with some embodiments of the technology described herein.

FIGS. 3A-3G provide illustrations of a graphical user interface for presenting information about at least one topic to a user, in accordance with some embodiments of the technology described herein.

FIGS. 4A-4B also provide illustrations of a graphical user interface for presenting information about at least one topic to a user, in accordance with some embodiments of the technology described herein.

FIG. 5 is a flowchart of an illustrative process, performed by at least one computer, for obtaining, organizing, and transmitting information about at least one topic to another device such that the transmitted information may be presented to a user of the device, in accordance with some embodiments of the technology described herein.

FIG. 6 is a diagram illustrating a data structure encoding metadata generated for a plurality of pieces of information about multiple topics, in accordance with some embodiments of the technology described herein.

FIG. 7 is a block diagram of an illustrative computer system that may be used in implementing some embodiments of the technology described herein.

### DETAILED DESCRIPTION

The inventors have recognized that the size of a display screen on a client device, for example, a mobile device such as a tablet or a mobile phone, limits the amount of information that can be simultaneously presented to a user and, as such, there may not be sufficient display screen space to simultaneously present different types of information about a topic of interest to the user, potentially when displaying information about multiple topics.

The inventors also recognized that users conventionally use multiple application programs and/or services to obtain different types of information about a topic of interest to them, which is inconvenient. For example, a user who wishes to make a reservation at a restaurant may obtain different types of information about the restaurant (e.g., information indicating whether reservations may be made for a particular time, directions to the restaurant, reviews of the restaurant, etc.) using different application programs and/or services (e.g., OpenTable®, a map application program, Yelp®, etc.). As another example, a user who wishes to obtain different types of information relevant to the stock price of a company (e.g., current stock price and its history, a news story about the company, information about the company's earnings, etc.) may obtain such information using different application programs and/or services.

Accordingly, some embodiments provide for a user interface configured to present to a user different types of information about a topic of interest to the user. The different types of information may be obtained from one or multiple different sources of information about the topic of interest. In this way, the user may obtain information about a topic of interest more efficiently because the user need not use multiple application programs and/or services to access the information.

In some embodiments, not all information about a topic that may be of interest to a user is presented simultaneously to the user. Additionally, display screen real estate may be further conserved by, for at least information that may of interest, providing no indication to the user that the information is even available for display (or at least providing no indicia describing content of the information). To allow the user to access this “hidden” information, one or more user gestures is pre-defined, and the user may execute the one or more gestures if/when the user desires to see the additional “hidden” information. For example, when the user desires to see an alternative type of information about a topic of interest (from the type of information about the topic being displayed), the user may indicate this desire to the user interface via a gesture (e.g., a horizontal swipe or other gesture) dedicated to causing alternative types of information about a topic to be displayed, and the user interface may present an alternative type of information about the topic to the user in response to detecting user input corresponding to the gesture. For example, a user interface may present to a user one type of information about a restaurant (e.g., a map showing directions to the restaurant) and, in response to user input corresponding to a gesture dedicated to causing alternative types of information about a topic to be displayed, presenting to the user an alternative type of information about the restaurant (e.g., reviews of the restaurant).

Accordingly some embodiments are directed to a user interface configured to present alternative types of information (e.g., content) about each of one or more topics to a user via a display of a client device (e.g., a mobile phone, a smart phone, a tablet, a wearable computing device such as wrist smart phone, etc.). The user interface may be configured to display (e.g., to cause the display of the device on which the user interface is executing to display) information about a first topic in a first content category and, in response to detecting user input corresponding to a particular type of gesture (e.g., a touch gesture such as a swipe in a horizontal swipe, a vertical swipe, a tap, etc.), display different information via the display. The information that is displayed in response to detecting user input corresponding to a gesture depends on the type of gesture detected. For example, in response to detecting a first type of gesture (e.g., a swipe in a horizontal direction such as to the left or right or any other suitable type of gesture) while displaying information about a first topic in a first content category, an alternative type of information about the first topic may be displayed. As another example, in response to detecting a second type of gesture (e.g., a swipe in the vertical direction such as up or down or any other suitable type of gesture) while displaying information about a first topic in a first content category, information about a second topic in a second content category may be displayed. As yet another example, in response to detecting a third type of gesture (e.g., a tap or any other suitable type of gesture) while displaying information about a first topic in a first content category, additional information about the first topic may be displayed. It should be appreciated that although each of the first, second, and third types of gestures may be any suitable type of gesture (examples of which have been provided), the first, second, and third types of gestures are different types of gestures.

Techniques described herein may be applied to presenting users with information about any suitable topic in any suitable content category. Examples of content categories include weather, sports, finance, shopping, dining, travel, music, movies, and/or any other suitable content or grouping of content. Examples of topics in content categories include, but are not limited to, the topic of weather in a location (e.g., town, city, state, area associated with a zip code, etc.) which is a topic in the weather content category, the topics of a particular sports team or a particular sport which are topics in the sports content category, the topic of a stock price which is a topic in the finance content category, the topic of a restaurant which is a topic in the dining category, the topic of a travel destination which is a topic in the travel content category. It should be appreciated that the techniques described herein are not limited to presenting users with information about the above-listed illustrative topics and may be used to present users with any suitable topic, as aspects of the technology described herein are not limited in this respect.

As discussed above, in some embodiments, a user interface may be configured to present a first type of information about a topic to a user and, while displaying that first type of information about the topic, respond to user input corresponding to a first type of gesture (e.g., a swipe in a particular direction, such as a horizontal swipe in a left or right direction, or any other suitable type of gesture) indicating that the user desires to be presented with an alternative type of information about the displayed topic by displaying one or more alternative types of information about the topic. As one non-limiting example, a user interface may present to a user one type of information about the weather in a location such as Boston (e.g., information about current temperature in Boston), and may respond to user input corresponding to a gesture indicating the user desires to see an alternative type of information about the displayed topic by presenting to the user an alternative type of information about the weather in the location (e.g., a weather radar map of the skies over Boston, the ten day forecast for Boston, online posts from people describing the current weather in Boston, information from the Farmers' Almanac, etc.). As another non-limiting example, a user interface may present to a user one type of information about a restaurant (e.g., contact information for the restaurant) and, in response to user input corresponding to a gesture indicating the user desires to see an alternative type of information about the displayed topic, the user interface may present to the user an alternative type of information about the restaurant (e.g. a map showing directions to the restaurant, reviews of the restaurant, a menu for the restaurant, a news article about the restaurant, etc.). As yet another non-limiting example, a user interface may present to a user one type of information about a sports team such as the New England Patriots (e.g., the current score of a game that the sports team is playing) and, in response to user input corresponding to a gesture indicating the user desires to see an alternative type of information about the displayed topic, the user interface may present to the user an alternative type of information about the sports team (e.g., information about the sports team's record and standings, articles about the sports team, the sports team's schedule of future games, tweets by the team's players and/or fans, etc.). As yet another non-limiting example, a user interface may present to a user one type of information about a stock (e.g., current price of a stock) and, in response to user input corresponding to a gesture indicating the user desires to see an alternative type of information about the displayed topic, the user interface may present to the user an alternative type of information about the stock (e.g., news about the company, information about stocks in the sector of the company, information about the company's earnings, information about corporate officers of the company, etc.).

As may be appreciated from the above-described non-limiting examples, in some instances alternative types of information (e.g., content) about a topic may be obtained from multiple sources different from each other. As one non-limiting example, a map showing directions to a restaurant may be obtained from one source (e.g., a map service such as Google Maps™, MapQuest®, etc.) and reviews of the restaurant may be obtained from a different source (e.g., Yelp®). As another non-limiting example, information about the current price of a stock of a company may be obtained from one source (e.g., Yahoo! Finance) and an article about the company may be obtained from another source (e.g., Bloomberg). As yet another non-limiting example, information about the schedule of a sports team may be obtained from one source and tweets by the team's players and/or fans may be obtained from another source (e.g., Twitter®). It should be appreciated that alternative types of information about a topic need not be obtained from different information sources and may, in some instances, be obtained from one information source. For example, information about the current price of a stock of a company and an article about the company may both be obtained from a single content provider such as Yahoo! Finance™ or Bloomberg®.

In some embodiments, alternative types of information (e.g., content) about a topic may comprise different content types (e.g., video content, audio content, image content, text-based content, streaming content, syndicated content such as Rich Site Summary (RSS) content feeds, etc.). As one non-limiting example, one type of information about a sports team may be text-based content comprising a schedule of future games of the sports team and an alternative type of information about the sports team may be video content showing a highlight of a game in which the sports team played. As another non-limiting example, one type of information about weather at a location may be text-based information indicating the current temperature at the location and an alternative type of information about the weather may be a video showing the evolution of a weather radar map over a period of time. As yet another non-limiting example, one type of information about a restaurant may be an image of a map showing directions to the restaurant and an alternative type of information about the restaurant may be streaming content of tweets on Twitter about the restaurant. It should be appreciated that alternative types of information about a topic need not comprise different content types and may, in some instance, comprise the same type of content.

In some embodiments, a user interface may detect, while displaying information (e.g., content) about a topic in one content category, user input corresponding to a second type of gesture (e.g., a swipe in a particular direction, such as a vertical swipe in an up or down direction, or any other suitable type of gesture) different from the first type of gesture described above and, in response to detecting the user input corresponding to the second type of gesture, may display to the user information (e.g., content) about another topic in a different content category. As one non-limiting example, the user interface may detect user input corresponding to the second type of gesture while displaying information about a topic in the sports content category (e.g., information about a sports team) and, in response to detecting the user input corresponding to the second type of gesture, may present the user with information about a topic in a different content category (e.g., about a topic in the finance content category or any topic in any suitable content category other than the sports content category).

In some embodiments, a user interface may detect user input corresponding to a third type of gesture (e.g., selecting a displayed item, for example by pressing the item, clicking the item, tapping the item, etc.) while displaying information (e.g., content) about a topic in a content category and, in response to detecting the user input corresponding to the third type of gesture, may display to the user additional information (e.g., content) about the topic. The additional information about the topic may be the same type of information as the information about the topic displayed when the user input corresponding to the third type of gesture was detected. The additional information about the topic may not be shown initially because the display of the device on which the user interface is executing may not have sufficient space to show the additional information about the topic. As one non-limiting example of displaying additional information about a topic, the user interface may detect user input corresponding to the third type of gesture while displaying contact information about a restaurant (e.g., the name and phone number for the restaurant) and, in response to detecting the user input corresponding to the third type of gesture, may display additional contact information about the restaurant (e.g., the street address, e-mail address, and/or web address of the restaurant). As another non-limiting example, the user interface may detect user input corresponding to the third type of gesture while displaying restaurant reviews about a restaurant and, in response to detecting the user input corresponding to the third type of gesture, may display additional restaurant reviews about the restaurant. As yet another non-limiting example, the user interface may detect user input corresponding to the third type of gesture while displaying tweets about a sports team and, in response to detecting the user input corresponding to the third type of gesture, may display additional tweets about the sports team. It should be appreciated that the above-described examples of additional information about a topic are illustrative and that any other suitable additional information about the topic may be displayed in response to detecting user input corresponding to a third type of gesture.

In some embodiments, a user interface configured to present information (e.g., content) about each of one or more topics to a user via a display of a client device may be configured to receive, directly or indirectly, the information about the topic(s) from one or more remote server(s) (or any other suitable remote computing device). The remote server(s) may obtain one or more pieces of content about the topic(s) from one or more content providers and provide (e.g., transmit) the obtained pieces of content to the client device. The remote server(s) may also generate metadata for the obtained pieces of content and provide the generated metadata to the client device. The metadata may comprise any suitable information that may be used by the user interface executing on the client device to facilitate presentation of the obtained content to the user.

In some embodiments, metadata generated by the remote server(s) for pieces of content about a topic may comprise information that may be used to determine which of the pieces of content about the topic to display first. As one non-limiting example, the remote server(s) may obtain a set of content about a restaurant (e.g., a piece of content specifying basic contact information for the restaurant such as the phone number of the restaurant, a piece of content comprising additional contact information for the restaurant such as an e-mail address for the restaurant, a piece of content comprising directions to the restaurant, a piece of content comprising one or more reviews of the restaurant, etc.), generate metadata specifying that the piece of content specifying basic contact information about the restaurant is to be displayed first, and transmit the generated metadata to a client device. In turn, a user interface executing on the client device may use the received metadata to determine that the piece of content specifying basic contact information for the restaurant is to be displayed first.

In some embodiments, the metadata generated for content about a topic may comprise information that may be used to determine which of the pieces of information about the topic to display in response to detecting user input corresponding to different types of gestures. As one non-limiting example, the metadata may comprise information that may be used to determine which of the pieces of content about the topic is to be displayed in response to detecting user input indicating that the user wishes to see an alternative type of content about the topic. For example, the metadata may comprise information that may be used by a user interface executing on the client device in determining that, in response to receiving user input (e.g., a horizontal swipe) indicating that the user wishes to see an alternative type of content about a restaurant while a piece of content specifying basic contact information for a restaurant is being displayed, the user interface is to display the piece of content comprising directions to the restaurant. As another example, the metadata may specify that, in response to receiving user input (e.g., another horizontal swipe) indicating that the user wishes to see an alternative type of content about a restaurant while the piece of content specifying directions to the restaurant is being displayed, the user interface is to display the piece of content comprising one or more reviews of the restaurant.

As another non-limiting example, the metadata may comprise information that may be used to determine which of the pieces of content about the topic is to be displayed in response to detecting user input indicating that the user wishes to see additional content about the topic, the additional content being of a same type as the content about the topic being displayed when the input is received. For example, the metadata may specify that, in response to receiving user input (e.g., a tap) indicating that the user wishes to see additional content about the restaurant of a same type as the content being displayed while the piece of content specifying basic contact information for the restaurant is being displayed, the piece of content comprising additional contact information for the restaurant is to be displayed.

As yet another non-limiting example, the metadata may comprise information that may be used to determine which of the pieces of content about another topic is to be displayed in response to detecting user input indicating that the user wishes to see content about a different topic. For example, the metadata may specify that, in response to receiving user input (e.g., a vertical swipe) indicating that the user wishes to see content about another topic in a different content category while a piece of content about a restaurant is being displayed, a piece of content about a sports team is to be displayed.

It should be appreciated that the embodiments described herein may be implemented in any of numerous ways. Examples of specific implementations are provided below for illustrative purposes only. It should be appreciated that these embodiments and the features/capabilities provided may be used individually, all together, or in any combination of two or more, as aspects of the technology described herein are not limited in this respect.

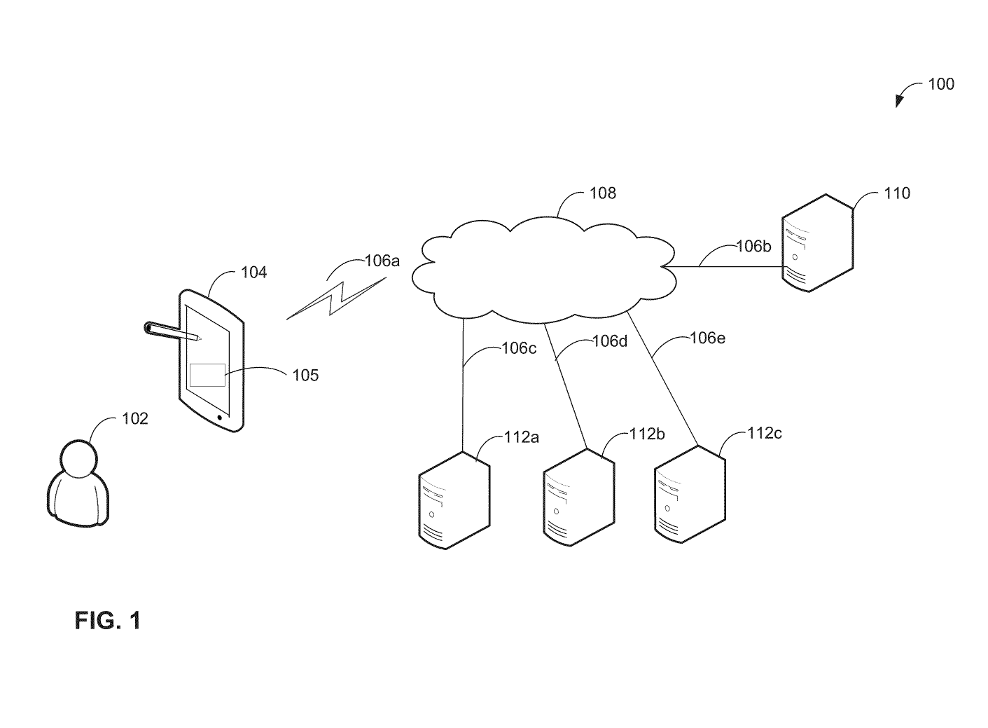

FIG. 1 shows an illustrative environment 100 in which some embodiments of the technology described herein may operate. In the illustrative environment 100, user interface 105 executing on computing device 104 may be configured to present user 102 with information about one or more topics of interest to the user. User interface 105 may obtain information about the topic(s) of interest to the user from remote server 110. Remote server 110 may be configured to obtain information about the topic(s) of interest from one or more content providers 112a-112c and/or any other suitable source(s) of content about the topic(s) of interest. In some embodiments, user interface 105 may be part of a standalone application program, while in other embodiments user interface 105 may be a part of an operating system executing on computing device 104.

In some embodiments, user interface 105 may be configured to present user 102 with one or more pieces of information about each of one or more topics of interest. User interface 105 may comprise processor-executable instructions that, when executed by at least one computing device (e.g., computing device 104), cause the at least one computing device to display the piece(s) of information about each of the topic(s). User interface 105 may be configured to present user 102 with any suitable number of pieces of information about a topic (e.g., one, two, three, four, five, at least five, at least ten, at least twenty, between two and twenty, between five and fifty, etc.), as aspects of the technology described herein is not limited in this respect. User interface 105 may be configured to present user 102 with information about any suitable number of topics (e.g., one, two, three, four, five, at least five, at least ten, at least twenty, between two and twenty, between five and fifty, etc.), as aspects of the technology described herein are not limited in this respect.

A piece of information may comprise any suitable type of content (e.g., text content, image content, audio and/or video content, streaming audio and/or video content, etc.). In some instances, two pieces of information about a topic may comprise the same type of information about the topic. As one non-limiting example, two pieces of information may comprise information obtained from a single content provider (e.g., a provider of information about weather, a provider of information about sports, or any other suitable information provider). As another non-limiting example, two pieces of information may comprise the same type of content, examples of which are provided herein. As another non-limiting example, one piece of information about a restaurant may comprise basic contact information for the restaurant (e.g., the phone number and street address for the restaurant) and another piece of information about the restaurant may comprise additional contact information for the restaurant (e.g., the e-mail address and web address for the restaurant). In some instances, two pieces of information about a topic may comprise alternative types of information about the topic. As one non-limiting example, one piece of information about a restaurant may comprise contact information for a restaurant and another piece of information about a restaurant may comprise an alternative type of information about the restaurant, for example, one or more reviews of the restaurant, a map of directions to the restaurant, a menu for the restaurant, a news article about a restaurant, etc. As another non-limiting example, one piece of information about Boston weather may comprise information about current temperature in Boston and another piece of information about the topic may comprise an alternative type of information about Boston weather, for example, a weather radar map of the skies over Boston, the ten day forecast for Boston, online posts from people describing the current weather in Boston, information from the Farmers' Almanac, etc.

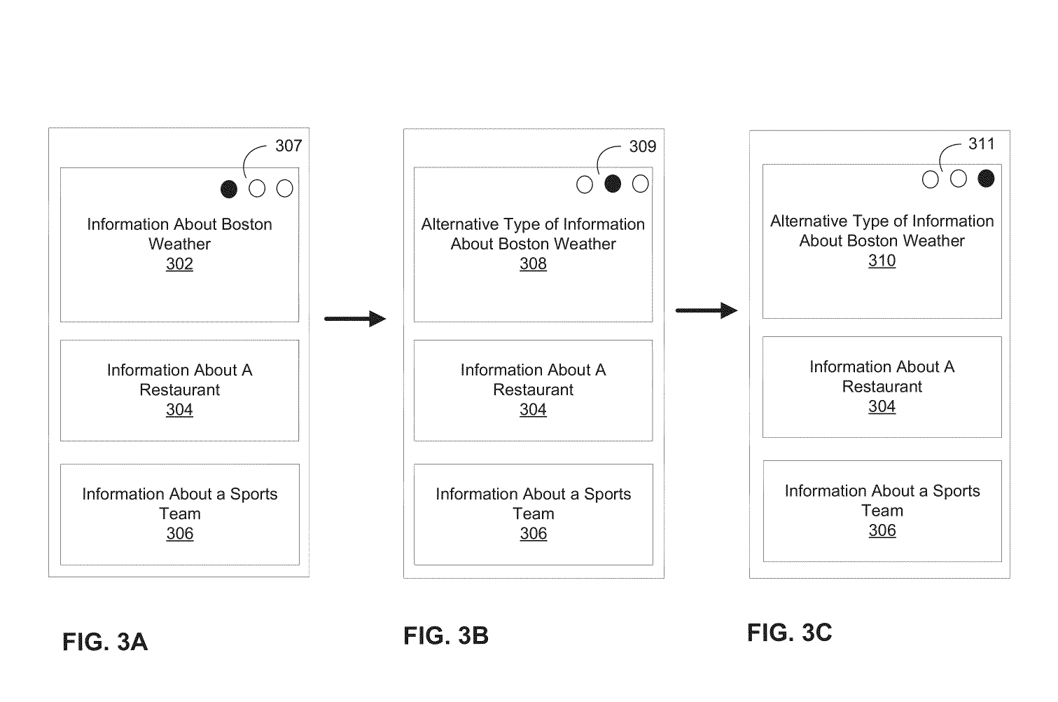

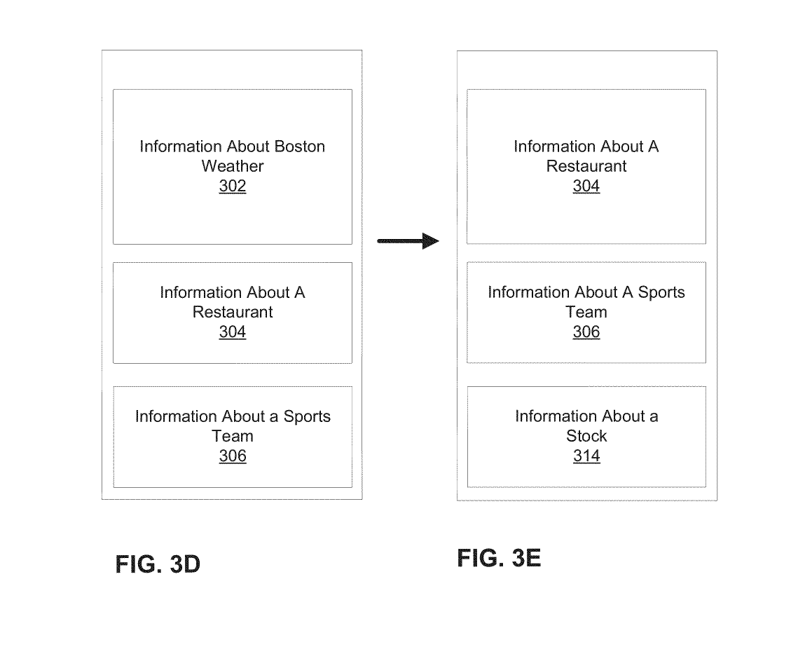

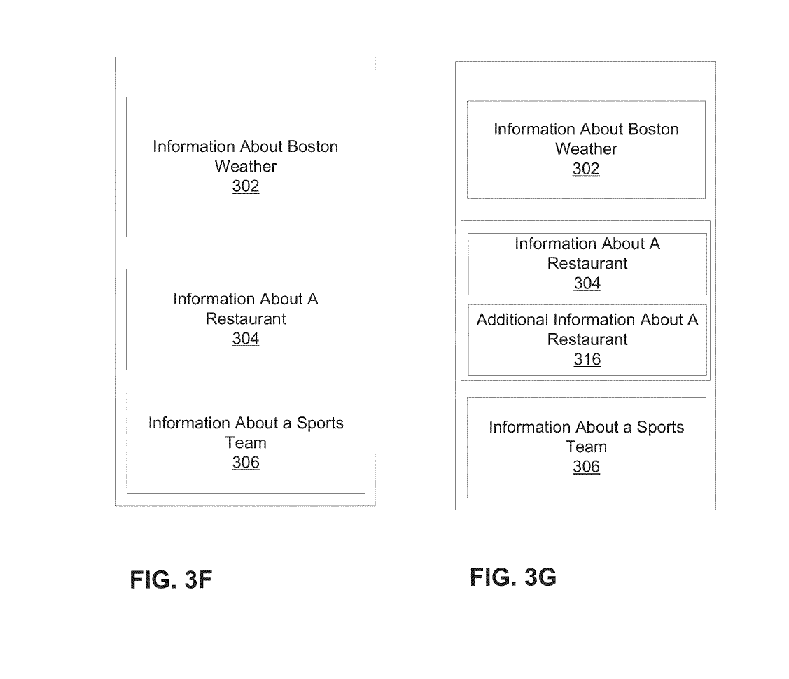

In some embodiments, user interface 105 may be configured to display a piece of information about a topic and, in response to detecting user input corresponding to a particular type of gesture, display a different piece of information about the topic. As one non-limiting example, the user interface 105 may display a first piece of information about a topic (e.g., basic contact information for the restaurant, current temperature at a location, price of a stock of a company, etc.) and, in response to detecting user input corresponding to a (e.g., a horizontal swipe) dedicated to causing an alternative type of information about the topic to be displayed, the user interface may display to the user a second piece of information comprising an alternative type of information about the topic (e.g., reviews of the restaurant, weather radar map for the location, a news article about the company, etc.). In some embodiments (e.g., in embodiments where the user interface 105 may be configured to display only one type of information about a topic), the user interface 105 may display the second piece of information instead of the first piece of information. For example, as shown in FIGS. 3A and 3B, a user interface 105 displaying information about Boston weather 302 (e.g., current temperature), information about a restaurant 304, and information about a sports team 306, displays, in response to detecting user input corresponding to a type of gesture indicating that the user wishes to see information alternative information about Boston weather (e.g., a horizontal swipe along at least a portion of the display screen displaying information about Boston weather 302), an alternative type of information about Boston weather 304 (e.g., a weather radar map of Boston), while displaying the same information about a restaurant 304, and the same information about a sports team 306.

As another non-limiting example, the user interface 105 may display an initial piece of information about a topic (e.g., basic contact information for the restaurant) and, in response to detecting user input corresponding to another type of gesture (e.g., a tap), display to the user a supplemental piece of information comprising additional information about the topic (e.g., additional contact information for the restaurant). The initial and supplemental pieces of information may comprise the same type of information and, in some embodiments, user interface 105 may concurrently display the initial and the supplemental pieces of information. For example, as shown in FIGS. 3F and 3G, a user interface 105 displaying information about a restaurant 304 (e.g., basic contact information), displays, in response to detecting user input corresponding to a tap on the area of the display screen showing information about the restaurant 304, additional information about the restaurant 316 (e.g., additional contact information).

In some embodiments, user interface 105 may be configured to display information about one topic and, in response to detecting user input corresponding to a type of gesture indicating that the user wishes to see information about a different topic, display information about a different topic. The user interface 105 may display information about one or more topics (e.g., weather at a location, a restaurant, a sports team) and, in response to detecting user input corresponding to a particular type of gesture (e.g., a vertical swipe), may display information about another topic (e.g., a stock of a company). In some embodiments, information about the other topic may be displayed instead of information about one or more topics for which information was displayed when the user input was detected. For example, as shown in FIGS. 3D and 3E, a user interface 105 displaying information about Boston weather 302, information about a restaurant 304, and information about a sports team 306, displays, in response to detecting user input corresponding to a type of gesture indicating that the user wishes to see information about a different topic, information about a restaurant 304, information about a sports team 306, and information about a stock of a company 308. Thus, information about a stock of a company is displayed instead of information about Boston weather 302. In other embodiments, however, information about the other topic may be displayed in addition to information about the topic(s) for which information was displayed when the user input was detected (e.g., by decreasing the amount of display screen space allotted to displaying information for each topic or in any other suitable way).

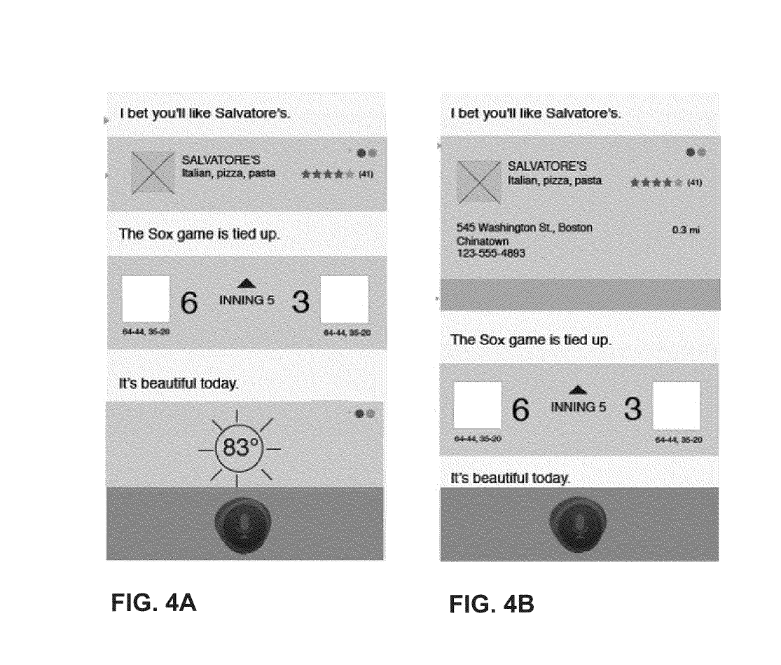

In some embodiments, user interface 105 may be configured to display only one type of information about a particular topic at any given time. For example, user interface 105 may be configured to display, at a particular time, only one type of information about a restaurant (e.g., contact information for the restaurant, a map of directions to the restaurant, reviews of the restaurant, or a news article about the restaurant). As another example, user interface 105 may be configured to display, at a particular time, only one type of information about weather at a location (e.g., current temperature, a weather radar map, the ten day forecast for Boston, online posts from people describing the weather in Boston, or information from the Farmer's Almanac). User interface 105 may be configured to display one type of information for each of multiple topics (see e.g., FIGS. 4A and 4B which illustrate presenting one type of information about each of three topics: a restaurant, a sports team, and weather at a location). It should be appreciated that user interface 105 is not limited to displaying only one type of information about a topic at any given time and, in some embodiments, may display multiple types of information about each of one or more topics.

In embodiments where user interface 105 may be configured to display only one type of information about a particular topic at any given time, the user interface 105 may provide an indication to the user that there is other content (e.g., an alternative type of content) that the user may view, but the indication may not provide any indicia to the user of what the other content is. For example, as shown in FIGS. 3A-3C, user interface 105 may present the user with indicators 307, 309, and 311 which inform the user that the user may view alternative types of information about Boston weather, but do not themselves provide any indicia as to the content of the alternative type of information. In this way, the user may be informed that an alternative type of information about Boston weather is available in a way that does not take up valuable space on the display screen of the computing device 104.

In some embodiments, user interface 105 may be configured to concurrently present user 102 with information about any suitable number of multiple topics (e.g., two topics, three topics, four topics, five topics, etc.). For example, as illustrated in FIGS. 3A-3G and 4A-4B, user interface 105 may concurrently present information to the user about three topics. The number of topics about which user interface 105 concurrently presents user 102 with information may depend on the size of the display of computing device 104. For example, when computing device 104 is a smart watch, the user interface 105 may present information for only one topic at a time because there is limited display space on the smart watch. As another example, when computing device 104 is a smart phone, the user interface 105 may concurrently present information for two, three, or four topics at a time.

User interface 105 may use any suitable graphical user interface to present information about one or more topics to user 102. In some embodiments, user interface 105 may concurrently present multiple pieces of information to the user such that the pieces of information are shown separately from one another. In some embodiments, a graphical user interface that utilizes cards may be employed. In such embodiments, a piece of information about a topic may be shown using a card graphical user interface element (hereinafter, “card”) that serves to visually encapsulate the piece of information. That is, graphical presentation of a card conveys encapsulation of the content associated with the card from content shown elsewhere on the display screen. A card may convey encapsulation in any suitable way (e.g., using borders, color, shading, opacity, etc.), as aspects of the technology described herein are not limited in this respect.

In some embodiments, multiple cards may be used to concurrently show respective multiple pieces of information about one or multiple topics. The multiple cards, when displayed, may serve to visually separate the respective pieces of information so that they appear separate from one another. For example, user interface 105 may concurrently show a piece of information for each of multiple topics by displaying each piece of information using a card (see e.g., FIGS. 3A-3G where each piece of information is displayed using a simple rectangular card, but note that a card is not limited to presenting information using rectangles of the type shown in FIGS. 3A-3G, as any suitable type of card may be used to display information about one or more topics).

Computing device 104 may be any electronic device that may execute one or more user interfaces to present user 102 with information about one or more topics. In some embodiments, computing device 104 may be a portable device such as a mobile smart phone, a personal digital assistant, a laptop computer, a table computer, a wearable computer such as a smart watch, or any other portable device that may execute one or more user interfaces to present user 102 with information about one or more topics. Alternatively, computing device 104 may be a fixed electronic device such as a desktop computer, a server, a rack-mounted computed, or any other suitable fixed electronic device that may execute one or more user interfaces to present user 102 with information about one or more topics.

Computing device 104 may be configured to communicate with server 110 via communication links 106a and 106b and network 108. Computing device and server 110 may be configured to communicate with content providers 112a-c via communication links 106a -106e and network 108. Network 108 may be any suitable type of network such as a local area network, a wide area network, the Internet, an intranet, or any other suitable network. Each of communication links 106a -106e may be a wired communication link, a wireless communication link, or any other suitable type of communication link. Computing device 104, server 110, and content providers 112a-c may communicate through any suitable communication protocol (e.g., a networking protocol such as TCP/IP), as the manner in which information is transferred among compute device 104, server 110 and content providers 112a-c is not limitation of aspects of the technology described herein.

In some embodiments, server 110 may identify one or more topics of interest to a user, obtain one or more pieces of content about the identified topics from one or more content providers (e.g., content providers 112a-112c), and transmit the obtained piece(s) of content to computing device 104 so that the piece(s) of content may be presented to user 102. In some embodiments, server 110 may generate metadata for the obtained content and provide the generated metadata to computing device 104, which in turn may use the generated metadata to inform the manner in which the pieces of content are displayed to the user 102. For example, the metadata may specify, directly or indirectly, which pieces of content are displayed first, what order the pieces of content are displayed in, which pieces of content correspond to alternative types of content about a particular topic, which pieces of content correspond to the same types of content about a topic, etc.). Server 110 may comprise one or more computing devices each having one or more computer hardware processors.

It should be appreciated that environment 100 is illustrative and that many variations are possible. For example, although server 110 is configured to obtain pieces information from content providers 112a-112c and transmit the obtained pieces of information to computing device 104 in the illustrated embodiment, in other embodiments, computing device 104 may be configured to obtain the pieces of information from content providers 112a-112c rather than from server 110. In such embodiments, server 110 may transmit information to computing device 104 identifying what pieces information to obtain and the content provider(s) from which to obtain the piece(s) of information, and computing device 104 may communicate with the identified content provider(s) to obtain the identified piece(s) of information.

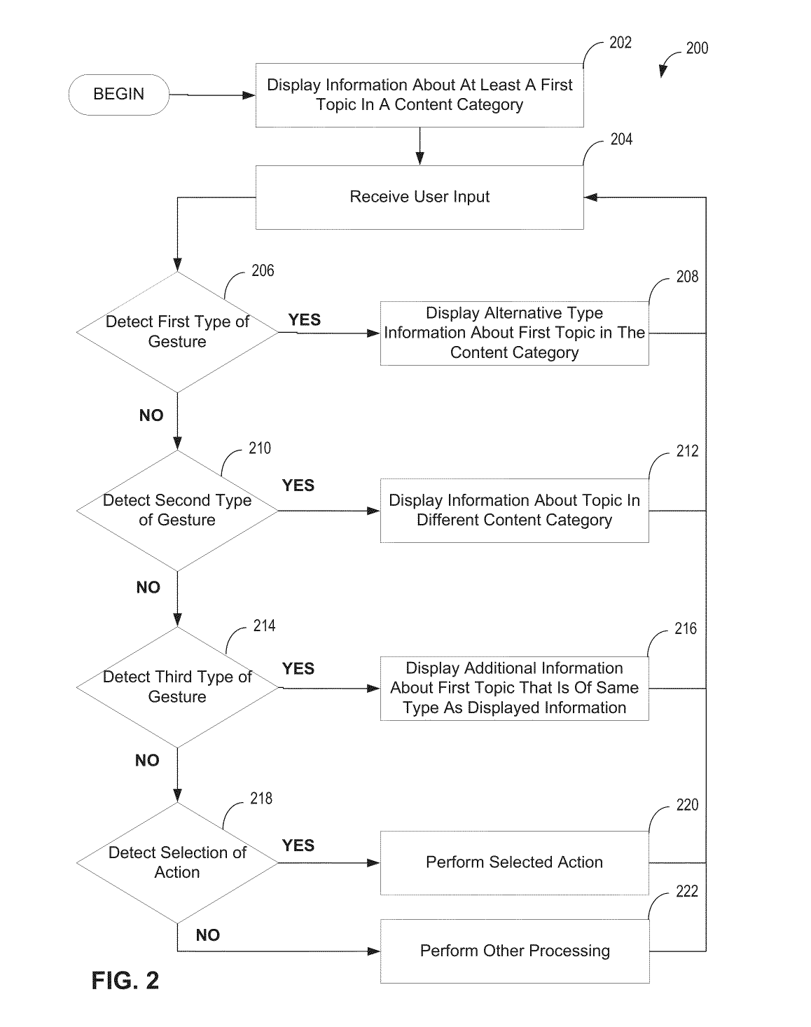

FIG. 2 is a flowchart of an illustrative process 200 for presenting information about at least one topic to a user, in accordance with some embodiments of the technology described herein. Illustrative process 200 may be performed using at least one computer hardware processor of any suitable computing device(s) and, for example, may be performed by using at least one computer hardware processor of computing device 104 described with reference to FIG. 1. In some embodiments, illustrative process 200 may be performed by a user interface (e.g., user interface 105) part of one or more application programs and/or an operating system executing on computing device 200.

Process 200 begins at act 202, where the computing device executing process 200 displays information about one or more topics, including a first topic, in one or more content categories to a user of the computing device. The computing device may display information about any suitable topic(s) in any suitable content category or categories. Examples of content categories and topics are provided above. Also, as discussed above, the computing device may display information about any suitable number of topics in any suitable number of content categories. For example, as illustrated in FIGS. 3A and 4A, the computing device executing process 200 may present a piece of information about each of three topics (e.g., weather at a location, a restaurant, and a sports team).

In some embodiments, the information about the topic(s) displayed at act 202 may comprise one or more pieces of information about the topic(s), and the computing device may display the piece(s) of information in respective portions (e.g., separate portions) of a display screen coupled to (e.g., integrated with) the computing device. The computing device may display the piece(s) of information in any suitable way and, in some embodiments, may display the piece(s) of information using one or more cards, as discussed above.

Next, process 200 proceeds to act 204, where the computing device executing process 200 receives input from a user of the computing device. In some embodiments, the user may provide input by gesturing (e.g., using at least one finger, a stylus, etc.) and the computing device may receiving input corresponding to the user's gesture. The user's gesture may be any suitable type of gesture including, but not limited to, a swipe in any suitable direction (e.g., a horizontal swipe to the left or right, a vertical swipe upward or downward, a diagonal swipe, a substantially straight swipe, a curved swipe, and/or any other suitable type of swipe), a tap, a double tap, a pinch, etc. The user's gesture may be substantially localized to a region of the display screen such that at least a threshold portion (e.g., at least fifty percent, at least sixty percent, at least seventy percent, etc.) of the input corresponding to the gesture is detected within the region of the display screen. The user's gesture may be a combination of multiple touches (e.g., a pinch gesture resulting from contacting the display screen with two fingers and bringing them closer together, double tapping the screen, etc.). It should be appreciated that the user's input is not limited to being a gesture and may be any other suitable type of input including any suitable input provided via a touch screen, input provided via a keyboard, input provided via a mouse, voice input, etc.

After the user's input is received at act 204, process 200 proceeds to decision blocks 206, 210, 214, and 218, where it is determined whether the user's input corresponds to a gesture that may indicate to the computing device what information about the one or more topic(s) is to be shown in response to receiving the gesture. The determination of whether a user provided input corresponding to a particular type of gesture, which determination is performed in decision blocks 206, 210, 214, and 218, may be performed in any suitable way, as aspects of the technology provided herein are not limited by the technique(s) which may be used to detect whether a user has provided input corresponding to a particular type of gesture. The order of decision blocks 206, 210, 214 and 218 (and corresponding acts 208, 212, 216, 220, and 222) is illustrative and may be altered, as aspects of the technology described herein are not limited by the order in which these decision blocks (and corresponding acts) are performed.

Next, process 200 proceeds to decision block 206, where it is determined whether the user's input corresponds to a first type of gesture indicating that the computing device is to display an alternative piece of information for a topic for which information was displayed at act 202. The type of gesture indicating that the computing device is to display an alternative piece of information about a topic may be a gesture substantially localized to a region of the screen displaying information about the topic. The type of gesture indicating that the computing device is to display an alternative piece of information about a topic may be a horizontal swipe or any suitable type of gesture.

In some embodiments, the type of gesture indicating that the computing device is to display an alternative piece of information about a topic may be a gesture dedicated to allowing the user to provide such an indication. Dedicating a gesture (regardless of what gesture it is) to providing this indication may make it easier for the user to learn how to provide the gesture and may reduce or eliminate the need to provide information to the user on the display indicating how to provide the gesture, which is advantageous as providing such information (e.g., text indicating to swipe horizontally to view an alternative type of information) may take up space on the display of the device executing process 200. Moreover, dedicating a gesture to allowing a user to provide an indication that the user desires an alternative type of information to be displayed may make it unnecessary to use display space to indicate the existence of alternative information to the user.

When it is determined at decision block 206 that the user has provided input corresponding to the first type of gesture for a topic (e.g., a horizontal swipe substantially localized to a region of the display screen displaying information about the topic), process 200 proceeds via the YES branch to act 208, where alternative information about the topic is displayed. For example, as shown in FIGS. 3A and 3B, in response to detecting that the user has provided input corresponding to the first type of gesture for the topic of Boston weather (e.g., a horizontal swipe substantially localized to a region of the display screen displaying information about Boston weather 302, such as current temperature), the computing device executing process 200 displays an alternative type of information about Boston weather 308 (e.g., weather radar map) instead of information about Boston weather 302. As another example, as shown in FIGS. 3B and 3C, in response to detecting that the user has provided input corresponding to the first type of gesture for the topic of Boston weather (e.g., a horizontal swipe substantially localized to a region of the display screen displaying information about Boston weather 308), the computing device executing process 200 displays an alternative type of information about Boston weather 310 (e.g., ten day forecast) instead of information about Boston weather 308. After act 208 is completed, process 200 returns back to act 204, where the computing device executing process 200 may receive additional user input.

On the other hand, when it is determined at decision block 206 that the user has not provided input corresponding to the first type of gesture for a topic, process 200 proceeds via the NO branch to decision block 210, where it is determined whether the user's input corresponds to a second type of gesture indicating that the computing device is to display a piece of information for a topic in another content category. The type of gesture indicating that the computing device is to display a piece of information about a topic in another content category may be a vertical swipe or any suitable type of gesture different from the first and third types of gestures.

When it is determined at decision block 208 that the user has provided input corresponding to the second type of gesture (e.g., a vertical swipe), process 200 proceeds via the YES branch to act 212, where information about another topic in a different content category is displayed. For example, as shown in FIGS. 3D and 3E, in response to detecting that the user provided input corresponding to the second type of gesture (e.g., a vertical swipe), the computing device executing process 200 displays information about a stock 314 instead of information about Boston weather 302. After act 212 is completed, process 200 returns to act 204, where the computing device executing process 200 may receive additional user input.

On the other hand, when it is determined at decision block 208 that the user has not provided input corresponding to a second type of gesture, process 200 proceeds via the NO branch to decision block 214, where it is determined whether the user's input corresponds to a third type of gesture indicating that the computing device is to display additional information about at topic of a same type as the information about the topic being displayed when the input is received (e.g., additional information of a same type as the information displayed about the topic at act 202). The type of gesture indicating that the computing device is to display an additional piece of information about a topic may be a gesture substantially localized to a region of the screen displaying information about the topic. The type of gesture indicating that the computing device is to display additional information about a topic may be a tap, a double tap, or any suitable type of gesture different from the first and second types of gestures.

When it is determined at decision block 214 that the user has provided input corresponding to the third type of gesture for a topic (e.g., a tap substantially localized to the region of the display screen showing information about the topic), process 200 proceeds via the YES branch to act 216, where additional information about the topic is displayed. For example, as shown in FIGS. 3F and 3G as well as in FIGS. 4A and 4B, in response to detecting that the user has provided input corresponding to the third type of gesture for the topic of a restaurant (e.g., a tap substantially localized to a region of the display screen displaying information about a restaurant 304, such as basic contact information for the restaurant), the computing device executing process 200 displays additional information about the restaurant (e.g., additional information about the restaurant 316 in addition to information about the restaurant 304). After act 216 is completed, process 200 returns to act 204, where the computing device executing process 200 may receive additional user input.

On the other hand, when it is determined at decision block 214 that the user has not provided input corresponding to the third type of gesture, process 200 proceeds via the NO branch to decision block 218, where it is determined whether the user has selected an action to be performed in connection with a topic for which information is being displayed. In some embodiments, at least some of the information being displayed about a topic may be associated with an action and the user may provide input indicating that the action is to be performed by the computing device performing process 200. For example, at least some of the information being displayed about a topic may be associated with the action of launching a user interface (different from the user interface executing process 200) such that the user may perform a task by using the launched user interface. For example, basic contact information for a restaurant may comprise a telephone number for the restaurant and may be associated with an action of launching a telephony application program so that the user may use the telephony application program to call the restaurant. As another example, directions to the restaurant may be associated with the action of launching a maps application program so that the user may use the maps application program to, for example, view a map of the driving directions to the restaurant.

The user may provide any suitable input to select an action to be performed in connection with a topic for which information is being displayed. In some embodiments, at least some of the information about a topic may be displayed using a selectable GUI element such that the user may select the GUI element (e.g., by tapping, clicking, etc.) to provide input indicating that the action associated with the information about the topic is to be performed. For example, a telephone number for a restaurant may be displayed using a selectable GUI element that the user may select (e.g., tap, click, etc.) to provide input indicating that the user wishes to call the restaurant using a telephony application program. As another example, directions to the restaurant may be displayed using a selectable GUI element such that the user may select the GUI element to provide input indicating the user wishes to use the maps application program. A user may provide any suitable type of input to select an action to be performed in connection with a topic for which information is being displayed, as aspects of the technology described herein are not limited in this respect.

In some embodiments, the determination that the user selected an action to be performed in connection with a topic for which information is being displayed may be performed by detecting that the user has selected a selectable GUI element used to display information about the topic or in any other suitable way.

When it is determined at decision block 218 that the user has selected an action to be performed, process 200 proceeds via the YES branch to act 220 where the selected action is performed. For example, when the at least some of the information about a topic is associated with an action of launching a user interface (e.g., telephony application program, maps application program, etc.) and the user selects the action, computing device 200 may launch the user interface and may provide the launched application program with the at least some of the information about the topic (e.g., provide the telephone number of the restaurant to the telephony application program, provide the address of the restaurant to the maps application program, etc.). After act 220 is completed, process 200 returns back to act 204, where the computing device executing process 200 may receive additional user input.

On the other hand, when it is determined at decision block 218 that the user did not select an action to be performed, process 200 proceeds to act 222, where the user input received at act 204 (which may be any other suitable input) is processed in any suitable way. That is, when the user provides input that is not one of the types of inputs described above with reference to decision blocks 206, 210, 214, and 218, such input may be processed at act 222 in any suitable way. After act 222 is completed, process 200 returns to act 204, where the computing device executing process 200 may receive additional user input.

As discussed above, a client computing device configured to present information about one or more topics to a user (e.g., computing device 104) may receive information about the topic(s) and associated metadata from a remote computing device (e.g., remote server 110). The remote computing device may obtain one or more pieces of information (e.g., content) about the topic(s) from one or more content providers, generate metadata for the obtained piece(s) of information, and transmit the piece(s) of information and the metadata to the client computing device. The client computing device may use the generated metadata to determine the manner in which to display the piece(s) of information to the user.

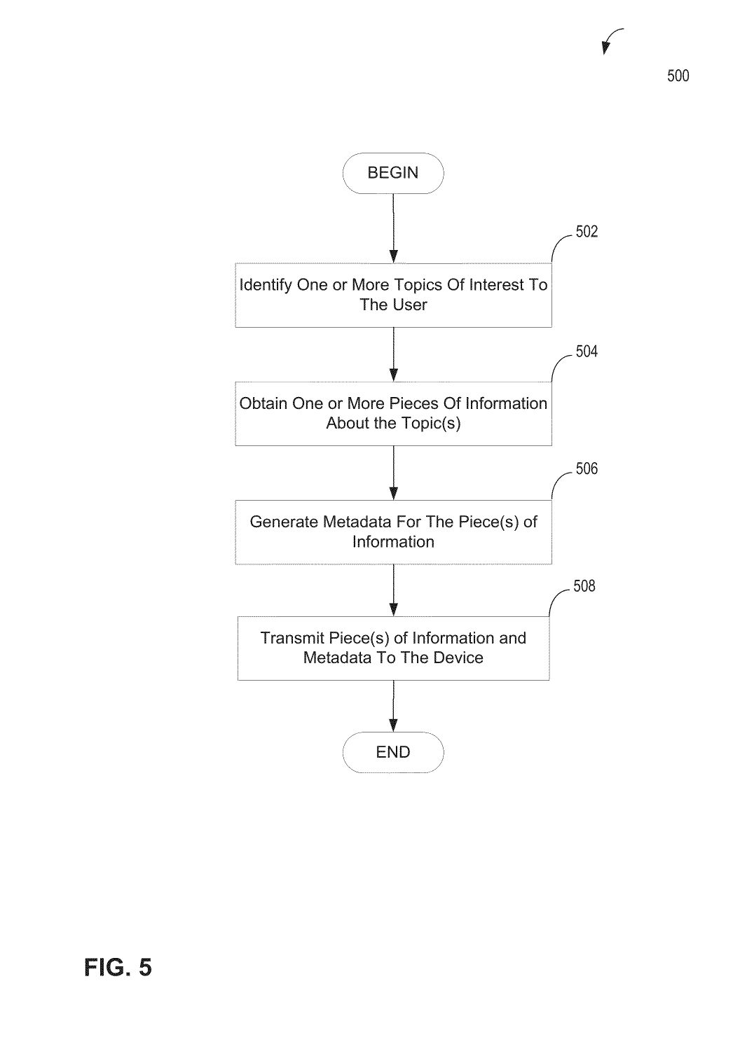

FIG. 5 is a flowchart of an illustrative process 500 for obtaining, organizing, and transmitting information about one or more topics to a client computing device (e.g., computing device 104) such that the client computing device may present the transmitted information about the topic(s) to a user. Process 500 may be performed by any suitable computing device or devices, one non-limiting example of which is remote server 110 described with reference to FIG. 1.

Process 500 begins at act 502, where one or more topics of interest to a user are identified based on information about the user. Information about a user may be information provided by the user (e.g., a search query, an indication of one or more topics of interest, etc.) and/or any other suitable information gathered about the user from any suitable source(s). In some embodiments, a user may provide information specifying one or more content categories and/or topics of interest to the user, and the topic(s) of interest to the user may be identified based on the provided information. As one non-limiting example, the user may provide a query (e.g., a free-form natural language query) specifying one or more content categories and/or topics to a user interface (e.g., user interface 105) configured to present information about one or more topics to a user and the specified topic(s) may be identified based on the query. For example, the user may provide the query “what is the phone number of Salvatore's?” from which it may be determined that the restaurant Salvatore's is a topic of interest to the user. As another example, the user may provide the query “football scores,” from which it may be determined that sports is a content category of interest to the user. As another non-limiting example, the user may specify topic(s) of interest to him/her by configuring settings of a user interface configured to present information about one or more topics to the user (e.g., by configuring settings of a user interface on the user's computing device to show information about the user's favorite football team, about weather in the location where the user lives, etc.).

In some embodiments, one or more topics of interest to the user may be inferred from information gathered about the user. For example, topic(s) of interest to the user may be inferred from the user's browsing history (e.g., when the user visits one or more websites containing information about a particular topic, it may be inferred that the user is interested in the particular topic), the user's activities on one or more websites (e.g., when the user views one or more news articles about particular topic, it may be inferred that the user is interested in the particular topic), interests of the user's contacts (e.g., when the user's Facebook® friends are interested in a particular topic, it may be inferred that the user is interested in the particular topic), information about the user stored in a user profile or any other suitable location(s) (e.g., demographic information, location information, etc.) may be used to infer that the user is interested in a particular topic (e.g., if a majority of white males aged 30-40 are interested in hometown football team scores on Sunday afternoon and the user is a 34 year old white male it may be inferred that the user is interested in seeing information about his hometown football team on Sunday afternoons during football season), etc.

After the topic(s) of interest to a user are identified at act 502, process 500 proceeds to act 504, where the computing device executing process 500 obtains one or more pieces of information (e.g., content) about the identified topic(s). Any suitable number of pieces of information about any suitable number of topics may be obtained at act 504. A piece of information about a topic may be obtained from any suitable source. For example, a piece of information about a topic (e.g., information about the current price of a stock of a company) may be obtained from a content provider that provides information about the topic (e.g., Yahoo! Finance™). As another example, the computing device executing process 500 may obtain information about a topic by searching for information about the topic using one or more search engines (e.g., one or more general-purpose search engines that index content across multiple web-sites such as Google™, or one or more site-specific search engines that index content hosted on a single web-site such as a search engine accessible via and configured to index content of the ESPN.com website, and/or one or more meta-search engines or aggregators configured to search for content by sending a search query to one or more other search engines). As yet another example, the computing device executing process 500 may have previously obtained information about a topic so that obtaining information about the topic, at act 504, comprises accessing the previously-obtained information. In some embodiments, alternative types of information about a topic may be obtained from different content providers. Examples of alternative types of information that may be obtained from different content providers have been described above.

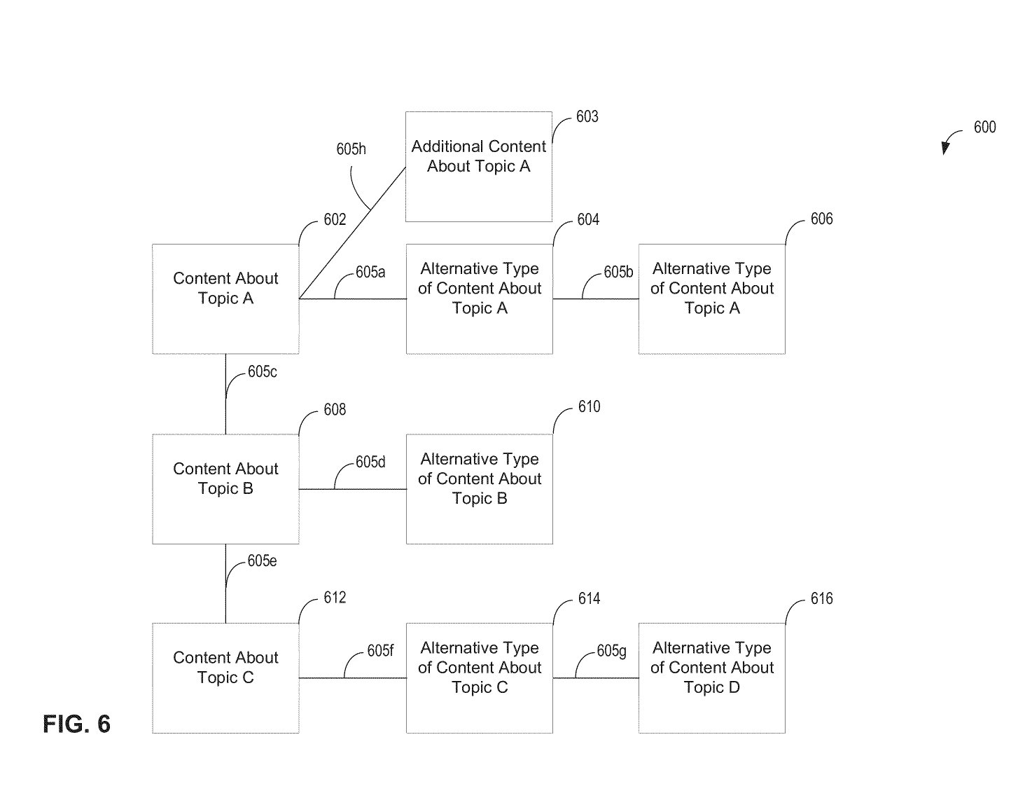

As one non-limiting example, illustrated in FIG. 6, topics A, B, and C may be identified as topics of interest to a user of a client computing device (e.g., computing device 104) at act 502, and pieces of information about the identified topics may be identified at act 504. As illustrated in FIG. 6, pieces of content 602, 604, and 606 about topic A, pieces of content 608 and 610 about topic B, and pieces of content 612, 614, and 616 about topic C, may be obtained at act 504 of process 500. In the illustrated example, pieces of content 602, 604, and 606 comprise alternative types of content about topic A and may be obtained from one or multiple content providers (i.e., pieces of content 602, 604, and 606 may be obtained from a single content provider, from two different content providers, or from three different content providers). In the illustrated example, pieces of content 608 and 610 comprise alternative types of content about topic B and may be obtained from one or multiple content providers. Similarly, pieces of content 612, 614, and 616 comprise alternative types of content about topic C and may be obtained from one or multiple content providers.

Next, process 500 proceeds to act 506, where metadata is generated for the piece(s) of information obtained at act 504. The generated metadata may comprise information that may be used to determine how to present a user with the pieces of information obtained at act 504. In some embodiments, the generated metadata may comprise information that may be used (e.g., by a client device such as computing device 104) to determine which of multiple pieces of information about a topic to display first. For example, metadata generated for the pieces of information shown in the example of FIG. 6 may indicate that the pieces of content to be shown first about topics A, B, and C, are pieces of content 602, 608, and 612, respectively. Accordingly, the generated metadata may be used by a client computing device to determine that pieces of content 602, 608, and 612 are to be displayed to the user initially, while pieces of content 604, 606, 610, 614, and 616 are not to be displayed to the user initially. As discussed below, one or more of the pieces of content 604, 606, 610, 614, and 616 may be displayed to a user in response to user input corresponding to different types of gestures.

In some embodiments, the generated metadata may comprise information that may be used to determine which of the pieces of information obtained at act 504 is to be displayed in response to detecting user input corresponding to different types of gestures (e.g., horizontal swipe, vertical swipe, tap, etc.). As one non-limiting example, the generated metadata may comprise information that may be used to determine which of the pieces of information about a topic is to be displayed in response to detecting user input indicating that the user wishes to see an alternative type of information about the topic. For example, the metadata generated for the pieces of information shown in the example of FIG. 6 may indicate that piece of content 604 (or 606) about topic A is to be displayed in response to detecting, while piece of content 602 (or 604) about topic A is being displayed, user input corresponding to a gesture (e.g., a horizontal swipe to the right) indicating that the user wishes to see an alternative type of information about the topic. As another non-limiting example, the generated metadata may indicate that piece of content 603 about topic A is to be displayed in response to detecting, while piece of content 602 about topic A is being displayed, user input corresponding to a gesture (e.g., a tap, a click, etc.) indicating that the user wishes to see additional information about the topic, the additional information being of a same type as the information about the topic being displayed when the input is received. As yet another non-limiting example, the generated metadata may comprise information that may be used to determine which of the pieces of information about another topic is to be displayed in response to detecting user input corresponding to a gesture (e.g., a vertical swipe) indicating that the user wishes to see information about a different topic.

In some embodiments, the metadata generated at act 506 may comprise at least one data structure representing relationships among pieces of information obtained at act 504. For example, the at least one data structure may indicate a corresponding topic for each of the one or more pieces of information obtained at act 504. As another example, the at least one data structure may indicate which of the pieces of information obtained at act 504 is to be displayed in response to detecting user input corresponding to different types of gestures (e.g., a first type of gesture indicating the user desires to see an alternative type of information about a topic, a second type of gesture indicating the user desires to see information about another topic, a third type of gesture indicating the user desires to see additional information about the topic of a same type as the information about the topic being displayed when the input is received, etc.)

As one non-limiting example of a data structure representing relationships among pieces of information obtained at act 504, the data structure 600 shown in FIG. 6 indicates that pieces of content 602, 604, and 606 are about topic A (e.g., weather in Boston) in a first content category (e.g., weather), that pieces of content 608 and 610 are about topic B (e.g., a particular restaurant) in a second content category (e.g., dining), and that pieces of content 612, 614, and 616 are about topic C (e.g., a sports team) in a third content category (e.g., sports). The data structure 600 indicates relationships among pieces of content using links 605a-h (e.g., pointers), which in turn may be used to determine which of the pieces of information is to be displayed in response detecting user input corresponding to different types of gestures. For example, in response to detecting, while displaying piece of content 602, user input indicating that the user desires to see an alternative type of information about topic A (e.g., a horizontal swipe), link 605a may be used to determine that piece of content 604 is to be displayed instead of piece of content 602. As another example, in response to detecting, while displaying piece of content 602, user input indicating that the user desires to see additional type of information about topic A of a same type as piece of content 602 (e.g., a tap, a click, etc.), link 605h may be used to determine that piece of content 603 is to be displayed in addition to (or instead of) piece of content 602. As yet another example, in response to detecting, while displaying piece of content 604, user input indicating that the user desires to see an alternative type of information about topic A (e.g., a horizontal swipe), link 605b may be used to determine that piece of content 606 is to be displayed instead of piece of content 604. As yet another example, in response to detecting, while displaying pieces of content 602 and 608, user input indicating that the user desires to see information about a topic in a different content category (e.g., a vertical swipe), link 605e may be used to determine that piece of content 612 about topic C is to be displayed.

After metadata is generated at act 506, process 500 proceeds to act 508, where the piece(s) of information obtained at act 504 and the metadata generated at act 506 are transmitted to a client computing device (e.g., computing device 104). The client computing device may display the piece(s) of information to a user of the client computing device based at least in part on the metadata. The piece(s) of information and metadata may be transmitted to the client device in any suitable way, as aspects of the technology described herein are not limited in this respect. After the piece(s) of information obtained at act 504 and the metadata generated at act 506 are transmitted to the client computing device, process 500 completes.

It should be appreciated that process 500 is illustrative and that there are variations of process 500. For example, although in the illustrated embodiment, the computing device(s) executing process 500 obtain piece(s) of information and send the obtained piece(s) to a client computing device, in other embodiments, the computing device(s) executing process 500 obtain information identifying the piece(s) of information (e.g., links to the piece(s) of information) and transmit that information to the client computing device. In turn, the client computing device uses the received information identifying the piece(s) of information to obtain the piece(s) of information. In this way, the client computing device may obtain content to display to a user from one or more content providers rather than from the computing device(s) executing process 500.

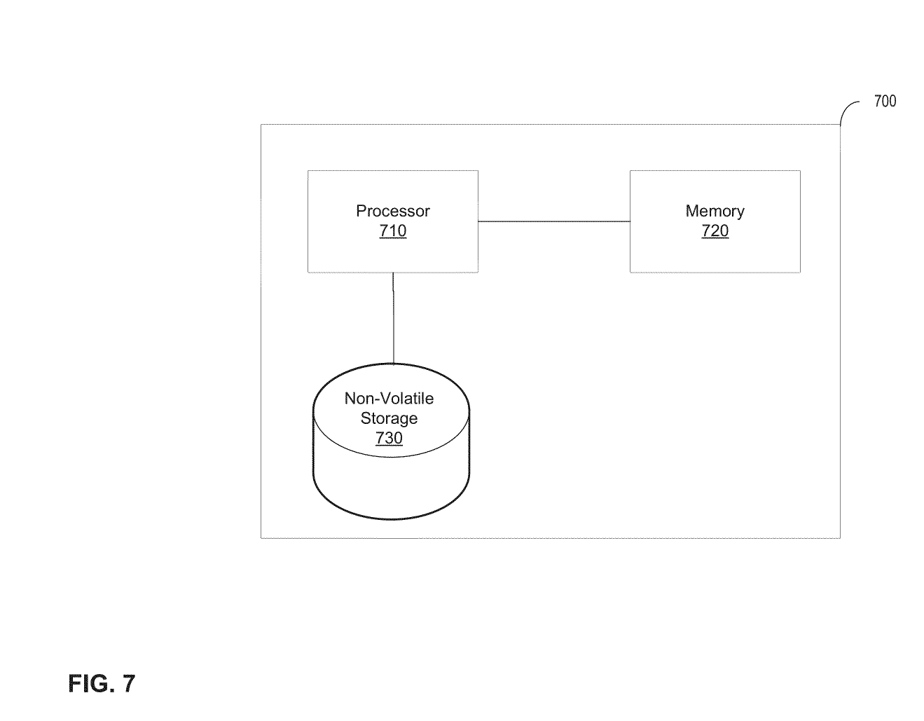

An illustrative implementation of a computer system 700 that may be used in connection with any of the embodiments of the disclosure provided herein is shown in FIG. 7. The computer system 700 may include one or more processors 710 and one or more articles of manufacture that comprise non-transitory computer-readable storage media (e.g., memory 720 and one or more non-volatile storage media 730). The processor 710 may control writing data to and reading data from the memory 720 and the non-volatile storage device 730 in any suitable manner, as the aspects of the disclosure provided herein are not limited in this respect. To perform any of the functionality described herein, the processor 710 may execute one or more processor-executable instructions stored in one or more non-transitory computer-readable storage media (e.g., the memory 720), which may serve as non-transitory computer-readable storage media storing processor-executable instructions for execution by the processor 710.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A method of presenting information to a user via a display of a device, the method comprising:
displaying information about a first topic in a first content category; and
while displaying the information about the first topic:
in response to detecting first user input corresponding to a first type of gesture, displaying information about a second topic in a second content category different from the first content category;
in response to detecting second user input corresponding to a second type of gesture, displaying first alternative type of information about the first topic, wherein no indicia describing content of the first alternative type of information about the first topic is displayed prior to detecting the second user input,
wherein, while information about a particular topic is being displayed, the second type of gesture is dedicated to causing an alternative type of information about the particular topic to be displayed, and
wherein the second type of gesture is different from the first type of gesture.

2. The method of claim 2, further comprising:
while displaying the information about the first topic:
in response to detecting user input corresponding to a third type of gesture, displaying additional information of a same type as the information about the first topic being displayed,
wherein the third type of gesture is different from the first type of gesture and from the second type of gesture.

3. The method of claim 1, wherein displaying the first alternative type of information about the first topic comprises displaying the first alternative type of information instead of the information about the first topic being displayed when the first user input is detected.

4. The method of claim 1, wherein the method further comprises:
while displaying the first alternative type of information about the first topic,
in response to detecting third user input corresponding to the second type of gesture, displaying a second alternative type of information about the first topic, wherein the second alternative type of information about the first topic is different from the first alternative type of information.

5. The method of claim 1, wherein the first type of gesture comprises a swipe in a first direction along the display of the device.

6. The method of claim 5, wherein the second type of gesture comprises a swipe in a second direction along the display of the device, and wherein the first direction is different from the second direction.

7. The method of claim 1, wherein the information about the first topic and the first alternative information about the first topic were obtained from different content providers.

8. The method of claim 1, wherein the information about the first topic is displayed using a GUI element, wherein at least a portion of the GUI element is selectable, and wherein the method further comprises:
in response to detecting selection of at least the first portion:
launching a user interface associated with the first content category; and
providing the user interface with access to the information about the first topic.

9. The method of claim 1, wherein the device is a mobile device.

10. At least one non-transitory computer-readable storage medium storing processor-executable instructions that when executed by at least one computer hardware processor cause the at least one computer hardware processor to perform a method of presenting information to a user via a display of a device, the method comprising:
displaying information about a first topic in a first content category; and
while displaying the information about the first topic:
in response to detecting first user input corresponding to a first type of gesture, displaying information about a second topic in a second content category different from the first content category;
in response to detecting second user input corresponding to a second type of gesture, displaying first alternative type of information about the first topic, wherein no indicia describing content of the first alternative type of information about the first topic is displayed prior to detecting the second user input, wherein, while information about a particular topic is being displayed, the second type of gesture is dedicated to causing an alternative type of information about the particular topic to be displayed, and
wherein the second type of gesture is different from the first type of gesture.

11. The at least one non-transitory computer-readable storage medium of claim 10, wherein the method further comprises:
while displaying the information about the first topic:
in response to detecting user input corresponding to a third type of gesture, displaying additional information of a same type as the information about the first topic being displayed,
wherein the third type of gesture is different from the first type of gesture and from the second type of gesture.

12. The at least one non-transitory computer-readable storage medium of claim 10, wherein displaying the first alternative type of information about the first topic comprises displaying the first alternative type of information instead of the information about the first topic being displayed when the first user input is detected.

13. The at least one non-transitory computer-readable storage medium of claim 10, wherein the method further comprises:
while displaying the first alternative type of information about the first topic,
in response to detecting third user input corresponding to the second type of gesture, displaying a second alternative type of information about the first topic, wherein the second alternative type of information about the first topic is different from the first alternative type of information.

14. The at least one non-transitory computer-readable storage medium of claim 10, wherein the first type of gesture comprises a swipe in a first direction along the display of the device.

15. The at least one non-transitory computer-readable storage medium of claim 14, wherein the second type of gesture comprises a swipe in a second direction along the display of the device, and wherein the first direction is different from the second direction.

16. A system, comprising:
at least one computer hardware processor; and
at least one non-transitory computer-readable storage medium storing processor-executable instructions that when executed by the at least one computer hardware processor cause the at least one computer hardware processor to perform a method of presenting information to a user via a display of a device, the method comprising:
displaying information about a first topic in a first content category; and
while displaying the information about the first topic:
in response to detecting first user input corresponding to a first type of gesture, displaying information about a second topic in a second content category different from the first content category;
in response to detecting second user input corresponding to a second type of gesture, displaying first alternative type of information about the first topic, wherein no indicia describing content of the first alternative type of information about the first topic is displayed prior to detecting the second user input,
wherein, while information about a particular topic is being displayed, the second type of gesture is dedicated to causing an alternative type of information about the particular topic to be displayed, and
wherein the second type of gesture is different from the first type of gesture.

17. The system of claim 16, wherein the method further comprises:
while displaying the information about the first topic:
in response to detecting user input corresponding to a third type of gesture, displaying additional information of a same type as the information about the first topic being displayed,
wherein the third type of gesture is different from the first type of gesture and from the second type of gesture.

18. The system of claim 16, wherein displaying the first alternative type of information about the first topic comprises displaying the first alternative type of information instead of the information about the first topic being displayed when the first user input is detected.

19. The system of claim 16, wherein the method further comprises:
while displaying the first alternative type of information about the first topic,
in response to detecting third user input corresponding to the second type of gesture, displaying a second alternative type of information about the first topic, wherein the second alternative type of information about the first topic is different from the first alternative type of information.

20. The system of claim 16, wherein the first type of gesture comprises a swipe in a first direction along the display of the device.
